(19) United States
(12) Patent Application Publication
(10) Pub. No.: US 2013/0307938 A1
(43) Pub. Date: Nov. 21, 2013

(54) STEREO VISION APPARATUS AND CONTROL METHOD THEREOF

(71) Applicant: SAMSUNG ELECTRONICS CO., LTD., Suwon-si (KR)

(72) Inventors: Dong Hoon Kim, Hwaseong-si (KR); Dong Woo Kim, Hwaseong-si (KR); Ki Hyun Yoon, Hwaseong-si (KR); Jun-Woo Jung, Hwaseong-si (KR); Jong Seong Choi, Hwaseong-si (KR)

(73) Assignee: SAMSUNG ELECTRONICS CO., LTD., Suwon-si (KR)

(21) Appl. No.: 13/830,929

(22) Filed: Mar. 14, 2013

(30) Foreign Application Priority Data
May 15, 2012 (KR) 10-2012-0051696

(51) Int. Cl. H04N 13/04

(52) U.S. Cl. CPC H04N 13/04
USPC 348/47; 348/51

(57) ABSTRACT

A method of controlling a stereo vision device includes calculating depth information by analyzing stereo images, setting regions of interest within each of the stereo images by using the depth information, and performing an auto focus operation on each of the regions of interest. The method may further include performing an auto exposure operation on each of the regions of interest.

### CROSS-REFERENCE TO RELATED APPLICATION

This application claims priority under 35 U.S.C. §119 to Korean Patent Application No. 10-2012-0051696 filed on May 15, 2012, the disclosure of which is incorporated by reference in its entirety herein.

### BACKGROUND

1. Technical Field

Embodiments of the present inventive concept relate to a 3D display technology, and more particularly, to a stereo vision apparatus for controlling Auto Focus, Auto Exposure and Auto White Balance (3A) and a control method thereof.

2. Discussion of Related Art

A 3D display technology provides a viewer with a 3D image by using a 3D display apparatus. The 3D display apparatus may be a stereo vision apparatus. The stereo vision apparatus is an apparatus for generating or improving illusion of depth of an image by presenting two offset images separately to the left eye and the right eye of a viewer.

Eye fatigue and discomfort may be prevented if the two offset images or stereo images have an identical quality. However, when several image sensors are used, it can be difficult to ensure that the stereo images maintain the identical quality.

For example, each of the image sensors having different exposure times or different auto white balance parameters contributes to the stereo images having different qualities. Thus, there is a need for methods or systems that ensure that the stereo images have an identical quality.

### SUMMARY

According to an exemplary embodiment of the present invention, a method of controlling a stereo vision apparatus includes calculating depth information by analyzing stereo images, setting regions of interest within each of the stereo images by using the depth information, and performing an auto focus operation on each of the regions of interest.

According to an exemplary embodiment, the method may further include performing an auto exposure operation on each of the regions of interest. According to an exemplary embodiment, the method may further include dividing each of the stereo images into sub regions according to the depth information and performing an auto white balance operation on each of the divided stereo images.

Each of the sub regions may include a different sub parameter. Addition of the sub parameters may result in an auto white balance parameter that can be used to perform the auto white balance operation.

According to an exemplary embodiment, the method may further include performing a color compensation operation on each of the auto focused stereo images.

The performing the color compensation operation may include selecting each of local regions from each of the auto focused stereo images and performing the color compensation operation on each of the selected local regions.

According to an exemplary embodiment of the present invention, a stereo vision apparatus includes image sensors outputting stereo images, lenses each located in front of each of the image sensors, an image signal processor calculating depth information by analyzing the stereo images and setting regions of interest within each of the stereo images by using the depth information, and an auto focus controller adjusting a location of each of the lenses to focus light on each of the regions of interest.

According to an exemplary embodiment, the stereo vision apparatus may further include an auto exposure controller adjusting an exposure time of each of the image sensors for each of the regions of interest.

The image signal processor may divide each of the stereo images into sub regions according to the depth information. Each of the sub regions may include a different sub parameter.

According to an exemplary embodiment, the stereo vision apparatus may further include an image auto white balance controller controlling each of the image sensors to perform an auto white balance operation on each of the divided stereo images.

The image signal processor may perform a color compensation operation on each of the auto focused stereo images. The image signal processor may select each of local regions from each of the auto focused stereo images according to the depth information, and perform the color compensation operation on each of the selected local regions. The stereo vision apparatus may be a 3D display apparatus.

According to an exemplary embodiment of the invention, a method of controlling a stereo image device includes calculating depth information from a pair of stereo images, defining a region of interest within each of the stereo images based on the depth information, where each region of interest surrounds only a part of the corresponding image, and performing an auto exposure operation only on the regions of interest.

The method may further include performing an auto focus operation only on the regions of interest. The method may further include dividing each stereo image into sub regions, wherein each sub region corresponds to a different depth, selecting the sub region with the smallest depth for each stereo image, and performing an auto white balance on each stereo image using the corresponding selected sub region. The method may perform a color compensation operation on each of the auto focused stereo images.

### BRIEF DESCRIPTION OF THE DRAWINGS

FIG. 1 is a block diagram of a stereo vision apparatus according to an exemplary embodiment of the present inventive concept;

FIG. 2 depicts exemplary stereo images generated by image sensors illustrated in FIG. 1;

FIG. 3 depicts exemplary stereo images including regions of interest set by an image signal processor illustrated in FIG. 1;

FIG. 4 is a diagram for explaining an operation of an auto focus controller illustrated in FIG. 1;

FIG. 5 is a graph for explaining an operation of the auto focus controller illustrated in FIG. 1;

FIG. 6 depicts exemplary images for explaining an operation of an auto white balance controller illustrated in FIG. 1;

FIG. 7 depicts exemplary images for explaining an exemplary embodiment of a color compensation operation performed by the image signal processor illustrated in FIG. 1;

FIG. 8 depicts exemplary histograms for explaining an exemplary embodiment of the color compensation operation performed by the image signal processor illustrated in FIG. 1;

FIG. 9 depicts exemplary images for explaining an exemplary embodiment of the color compensation operation performed by the image signal processor illustrated in FIG. 1; and

FIG. 10 is a flowchart for explaining an operation of the stereo vision apparatus illustrated in FIG. 1 according to an exemplary embodiment of the present inventive concept.

### DETAILED DESCRIPTION

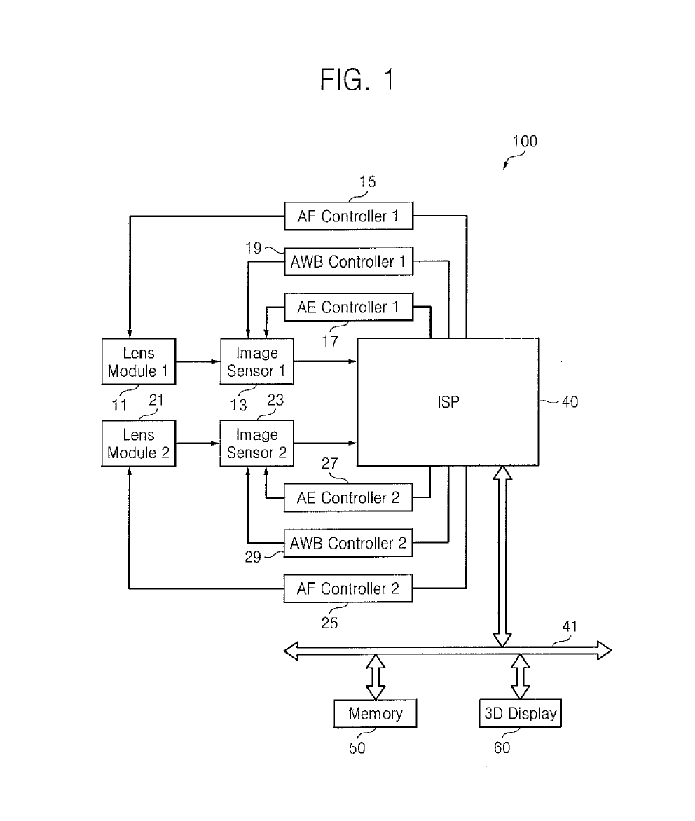

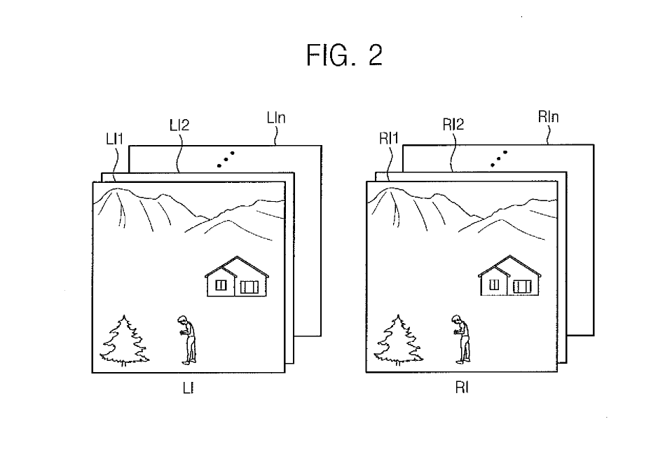

FIG. 1 is a block diagram of a stereo vision apparatus according to an exemplary embodiment of the present inventive concept, and FIG. 2 depicts exemplary stereo images generated by image sensors illustrated in FIG. 1. Referring to FIGS. 1 and 2, a stereo vision device 100 provides a viewer with 3D images by displaying stereo images on a 3D display 60.

For example, the stereo vision device 100 may be a 3D display device such as a mobile phone, a tablet personal computer (PC), or a laptop computer.

The stereo vision device 100 includes lens modules 11 and 21, image sensors 13 and 23, auto focus controllers 15 and 25, auto exposure controllers 17 and 27, auto white balance controllers 19 and 29, an image signal processor (ISP) 40, a memory 50 and the 3D display 60. The first image sensor 13 may capture left-eye images LI for the left eye and the second image sensor 13 may capture right-eye images RI for the right eye. The first lens module 11 may focus light onto the first image sensor 13 to enable the first image sensor 13 to capture the left-eye images LI. The second lens module 21 may focus light onto the second image sensor 23 to enable the second image sensor 23 to capture the right-eye images RI. Each, pair of the left-eye and right-eye images LI and RI may be referred to as a pair of stereo images since they can be used to generate a 3D image.

The memory 50 may store the stereo images (LI and RI), which are processed by the ISP 40. The memory 50 may be embodied as a read only memory (ROM), a programmable read only memory (PROM), an erasable programmable read only memory (EPROM), an electrically erasable programmable read only memory (EEPROM), a flash memory, a ferroelectrics random access memory (FRAM), a magnetic random access memory (MRAM), a phase change random access memory (PRAM), a nano random access memory (NRAM), a silicon-oxide-nitride-oxide-silicon (SONOS), a resistive memory or a racetrack memory.

The 3D display 60 may display the stereo images LI and RI processed by the ISP 40. Each element 40, 50, and 60 may communicate with each other through a bus 41. Examples of the bus 41 include a PCI express bus, a serial ATA bus, a parallel ATA bus, etc.

Each of image sensors 13 and 23 generates each of stereo images LI and RI through each of lens modules 11 and 21. The first image sensor 13 may generate left images LIi (e.g., where i ranges from 1 to n, collectively called ‘LI’). The left images LI include a plurality of left images LI1 to LIn, where n is a natural number. The second image sensor 23 may generate right images RIi (e.g., where i ranges from 1 to n, collectively called ‘RI’). The right images RI include a plurality of right images RI1 to RIn, where n is a natural number.

For convenience of explanation, two image sensors 13 and 23 and two lens modules 11 and 21 are illustrated in FIG. 1. However, the number of image sensors and lens modules may vary in alternate embodiments. For example, when the number of image sensors and lens modules is 4, respectively, images generated by two of the image sensors may be used to form left images LI and images generated by the remaining two image sensors may be used to form right images RI.

In an exemplary embodiment, the ISP 40 is used to control each of elements 13, 15, 17, 19, 23, 25, 27 and 29 of the stereo vision apparatus 100. In an alternate embodiment, one or more additional ISPs may be used to control one or more of these elements.

The ISP 40 may analyze the stereo images LI and RI output from the image sensors 13 and 23 and calculate depth information according to a result of the analysis. For example, the ISP 40 may calculate depth information by using a window matching method or a point correspondence analysis.

For example, the ISP 40 may set at least one window for each of the stereo images LI and RI or detect feature points from each of the stereo images LI and RI. When windows are set, magnitude, location or the number of the window may be varied according to an exemplary embodiment. For example, the ISP 40 may define a window within a left or right image that is smaller than the corresponding image for detecting the feature points therefrom.

The feature points may indicate a part or points of the stereo images LI and RI that are of interest to processing an image. For example, feature points may be detected by an algorithm like a scale invariant feature transform (SIFT) or a speeded up robust feature (SURF).

The ISP 40 may compare windows of each of the stereo images LI and RI with each other or compare feature points of each of the stereo images LI and RI with each other, and calculate depth information according to a result of the comparison. When the ISP 40 compares the windows of each of the stereo images, it may compare only the feature points that are enclosed within the corresponding windows. The depth information may be calculated by using disparities of the stereo images LI and RI. The depth information may be displayed in or represented by gray scale values.

For example, objects that are closest to each of the image sensors 13 and 23 may be displayed in white and objects farthest away from each of the image sensors 13 and 23 may be displayed in black. For example, closer objects may appear brighter and farther objects may appear darker, with corresponding representative gray scale values.

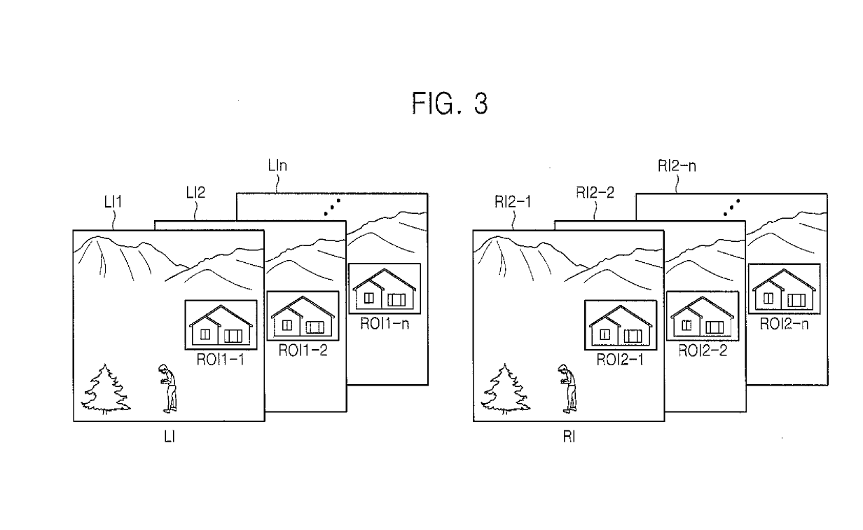

FIG. 3 depicts images each including regions of interest set by the image signal processor 40 illustrated in FIG. 1. Referring to FIGS. 1 and 3, the ISP 40 may set the regions of interest, e.g., ROI1-1 to ROI1-n and ROI2-1 to ROI2-n for each of the stereo images LI and RI by using depth information.

For example, the ISP 40 may arbitrarily determine a distance between each of the image sensors 13 and 23 and an object (e.g., a house) by using calculated depth information, and set each of the regions of interest ROI1-1 to ROI1-n and ROI2-1 to ROI2-n including the object (e.g., a house) for each of the stereo images LI and RI according to a determined distance.

The size and/or shape of the regions of interests ROI1-1 to ROI1-n and ROI2-1 to ROI2-n may be varied according to an exemplary embodiment. In an exemplary embodiment, each of regions of first interest ROI1-1 to ROI1-n and each of regions of second interest ROI2-1 to ROI2-n have an identical size and/or shape. For example, a left or right image could include several objects of interest, where each is a different distance away from respective image sensor. All points that are a certain distance away or are within a certain distance range from the respective sensor (e.g., at a certain depth) could correspond to one of the regions of interest. An object of interest in a scene can be chosen using the depth information (e.g., 30% depth could be used to select an optimal region of interest). For example, the object having a middle depth in the foreground objects can be selected to calculate an autofocus. Use of the regions may allow autofocus to be more efficient since the autofocus need not focus on the entire image, but only the selected region or the one with the highest frequency.

In a further exemplary embodiment, each location of regions of the first interest ROI1-1 to ROI1-n is the same as each location of regions of the second interest ROI2-1 to ROI2-n. For example, the offset of the first region within the regions of first interest ROI1-1 may be the same as the offset of the first region within the regions of second interest to ROI2-n. One or more regions of interest may be included in each of the stereo images LI and RI according to an exemplary embodiment. Each of regions of interest ROI1-1 to ROI1-n and ROI2-1 to ROI2-n may be used to perform an auto focus operation and/or an auto exposure operation.

The ISP 40 controls auto focus controllers 15 and 25 to perform an auto focus operation on each of the regions of interest ROI1-1 to ROI1-n and ROI2-1 to ROI2-n.

According to an exemplary embodiment, the stereo vision device 100 includes a single auto focus controller instead of two auto focus controllers 15 and 25 to control each of the lens modules 11 and 21.

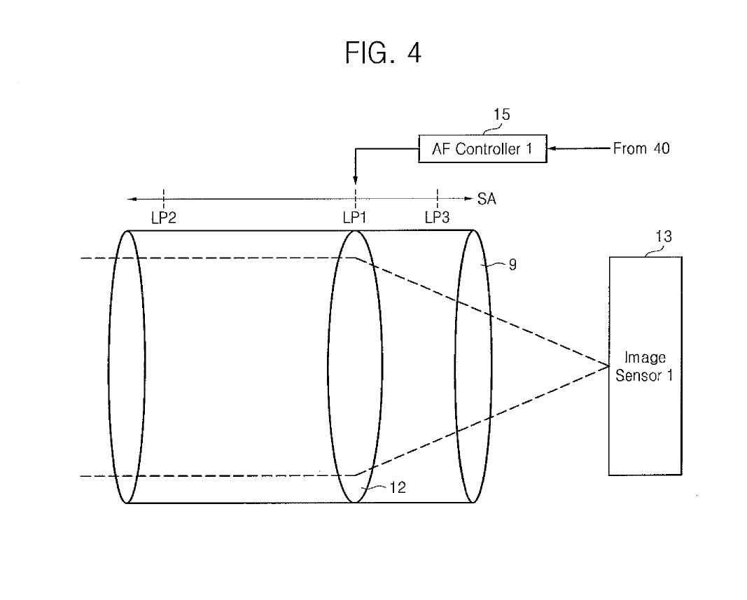

FIG. 4 is a diagram for explaining an operation of the auto focus controller illustrated in FIG. 1. Referring to FIGS. 1 through 4, a first lens module 11 includes a barrel 9 and a lens 12. The lens 12 may be moved inside the barrel 9.

A first auto focus controller 15 may control movement of the lens 12 under a control of the ISP 40. The lens 12 may move inside a searching area (SA) under a control of the first auto focus controller 15. For example, the lens 12 may move in a linear fashion to different locations (e.g., LP1 to LP3) within the area SA. The ISP 40 may measure different contrast values based on each of locations LP1 to LP3 of the lens 12 in each of regions of the first interest ROI1-1 to ROI1-n. A structure and an operation of a second auto focus controller 25 may be substantially the same as a structure and an operation of the first auto focus controller 15.

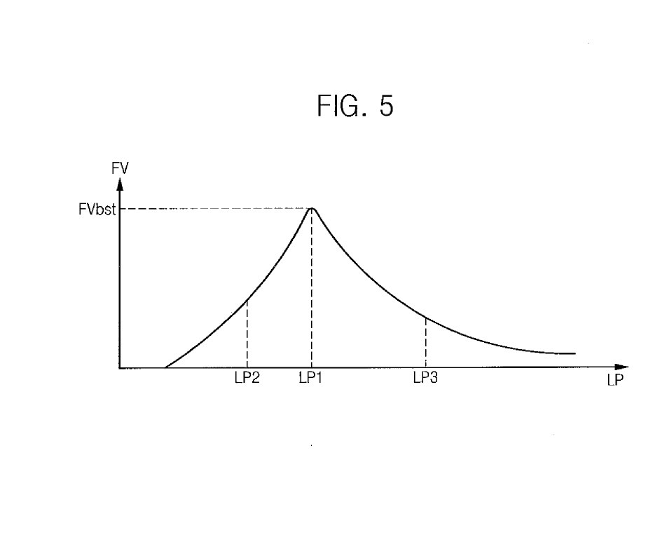

FIG. 5 is a graph for explaining an operation of the auto focus controller illustrated in FIG. 1. In FIG. 5, an X axis indicates a distance between the lens 12 and the first image sensor 13 illustrated in FIG. 4, and a y axis indicates a focus value.

Referring to FIGS. 1 through 5, a contrast value may correspond to a focus value FV illustrated in FIG. 5.

In an exemplary embodiment, the ISP 40 controls the first auto focus controller 15 so that the left images LI may have the highest focus value FVbst. The first auto focus controller 15 adjusts a location of the lens 12 so that the lens 12 may be located at a location LP1 corresponding to the highest focus value FVbst under a control of the ISP 40.

Even when each of the stereo images LI and RI has a complicated background like natural scenes or a moving object, the stereo vision device 100 is capable of setting each of the regions of interest ROI1-1 to ROI1-n and ROI2-1 to ROI2-n for each of the stereo images LI and RI according to depth information, and performs an auto focus operation on each of the regions of interest ROI1-1 to ROI1-n and ROI2-1 to ROI2-n. Accordingly, the stereo images LI and RI may have an identical quality.

The ISP 40 controls auto exposure controllers 17 and 27 to perform an auto exposure operation on each of the regions of interest ROI1-1 to ROI1-n and ROI2-1 to ROI2-n.

Each of the auto exposure controllers 17 and 27 controls an exposure time of each of the image sensors 13 and 23. In an exemplary embodiment, ‘exposure time’ indicates how long a photodiode (not shown) included in each image sensor 13 or 23 is exposed to an incident light. Even when each background of the stereo images LI and RI has a large amount of sunlight or light intensity (e.g., from a bright sky), the stereo vision device 100 may perform an auto exposure operation on each of the regions of interest ROI1-1 to ROI1-n and ROI2-1 to ROI2-n. Accordingly, each of the stereo images LI and RI may have an identical quality. According to an exemplary embodiment of the inventive concept, the stereo vision device 100 includes a single auto exposure controller instead of the two auto exposure controllers 17 and 27.

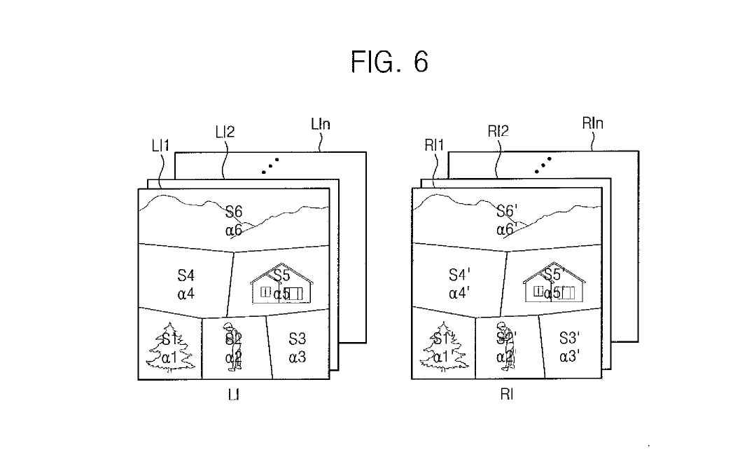

FIG. 6 depicts exemplary images for explaining an operation of an auto white balance controller illustrated in FIG. 1. Referring to FIGS. 1 through 6, the ISP 40 may divide each of the stereo images LI and RI into each of sub regions S1 to S6 and S1′ to S6′ according to depth information calculated by the ISP 40. The sub regions may have various shapes and locations and are not limited to the shapes shown in FIG. 6. Each sub region may correspond to a portion of a captured image a particular distance away from a respective image sensor. For example, a first sub region S1 may be a region having the closest distance between the image sensor 13 and an object, and a second sub region S6 may be a region having a farthest distance between the image sensor 13 and the object.

Each of sub parameters α₁ to α₆ correspond to each of sub regions S1 to S6 divided from the image LI. In addition, each of sub parameters α₁′ to α₆′ corresponds to each of sub regions S1′ to S6′ divided from the image RI. Each of the sub parameters α₁ to α₆ may be the same as each of the sub parameters α₁′ to α₆′, respectively. The addition of the sub parameters α₁ to α₆ results in an auto white balance parameter αₜₒₜₐₗ. The auto white balance parameter αₜₒₜₐₗ is represented by the following equation 1.

$${α}_{total} = {\sum }_{i = 0}^{P} {α}_{i} \qquad [ Equation 1 ]$$

Here, the i indicates an order of sub parameters, the αᵢ indicates a i^{th} sub parameter, and the P indicates a natural number.

The auto white balance parameter αₜₒₜₐₗ may be a red component, a green component, or a blue component. From the red component, the green component, and the blue component, each color of pixels included in the stereo images LI and RI is displayed.

The ISP 40 controls auto white balance controllers 19 and 29 to perform an auto white balance operation. The auto white balance operation is performed by adjusting the auto white balance parameter αₜₒₜₐₗ. An adjusted auto white balance parameter α_{adj} is represented by the following equation 2.

$${α}_{adj} = {\sum }_{i = 0}^{P} {w}_{i} {α}_{i} \qquad [ Equation 2 ]$$

Here, the α_{adj} indicates an adjusted auto white balance parameter, the αᵢ indicates an i^{th} sub parameter, and the wᵢ indicates a gain or a weight corresponding to an adjusted i^{th} auto white balance parameter α_{adj}. The weight may correspond to a size of a corresponding region.

Each of the auto white balance controllers 19 and 29 controls each of the image sensors 13 and 23 under a control of the ISP 40 to adjust each of gains wᵢ.

Even when each of the stereo images LI and RI are based on mixed light sources or a large object, the stereo vision device 100 may perform an auto white balance operation by fractionating each of the stereo images LI and RI into the sub regions. Therefore, each of the stereo images LI and RI may have an identical quality. According to an exemplary embodiment, the stereo vision device 100 includes one auto white balance controller instead of the two auto white balance controllers 19 and 29.

In an exemplary embodiment, the lightest one of the sub regions S1 to S6 is assumed to be white and is used to color balance the entire image. One of the sub regions S1 to S6 (e.g., S1) may correspond to points within the stereo image that are at a same first depth or same first depth range, while another one of the sub regions (e.g., S2) may correspond to points within the stereo image that are at a same second depth or same second depth range, where the first depth differs from the second depth, and the first depth range differs from the second depth range.

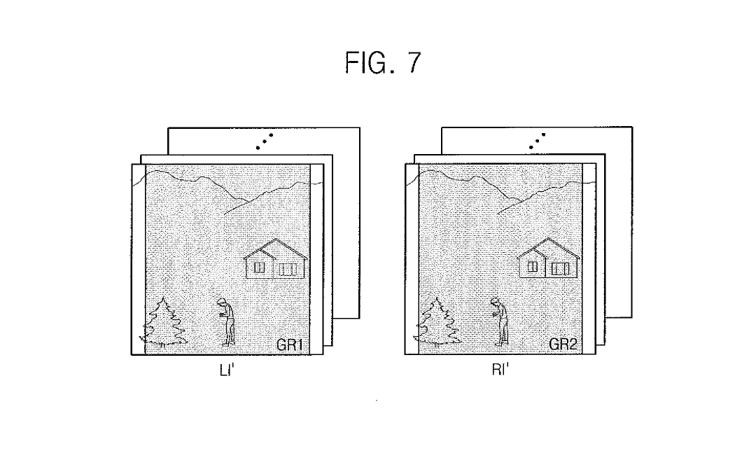

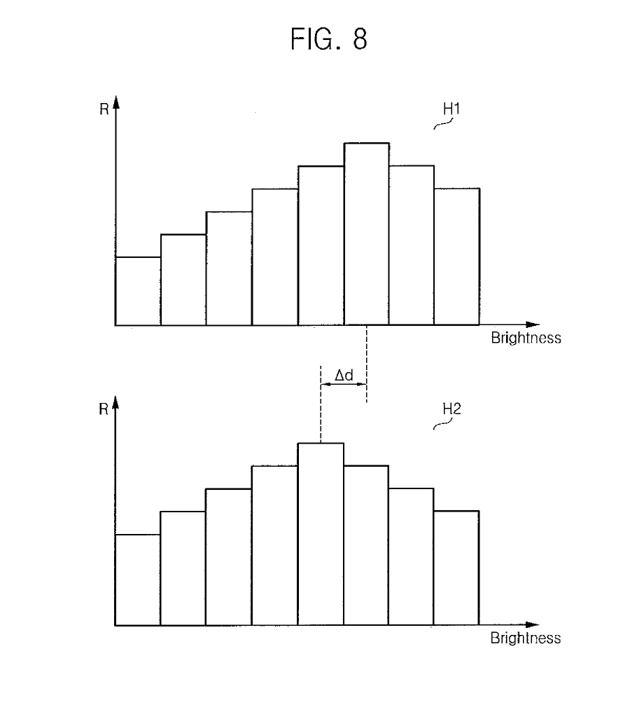

FIG. 7 depicts exemplary images for explaining an exemplary embodiment of a color compensation operation performed by the image signal processor illustrated in FIG. 1 according to an exemplary embodiment of the invention, and FIG. 8 depicts exemplary histograms for explaining an exemplary embodiment of the color compensation operation performed by the image signal processor illustrated in FIG. 1.

Referring to FIGS. 1 through 8, even though the stereo vision device 10 controls auto focus, auto exposure and auto white balance (3A), a color compensation of each of stereo images LI′ and RI′ may be requested so that each of the stereo images LI′ and RI′ have an identical quality.

Accordingly, the ISP 40 may perform a color compensation operation on each of the stereo images LI′ and RI′. Each of the stereo images LI′ and RI′ correspond to images resulting from an auto focus operation, an auto exposure operation and/or an auto white balance operation being performed on each of the stereo images LI and RI.

The ISP 40 overlaps the stereo images LI′ and RI′ with each other and calculates overlapped regions GR1 and GR2. The ISP 40 calculates color similarity of the overlapped regions GR1 and GR2. For example, the ISP 40 may generate each of histograms H1 and H2 indicating a brightness distribution of each of the overlapped regions GR1 and GR2.

A first histogram H1 indicates a brightness distribution of a first region GR1 and a second histogram H2 indicates a brightness distribution of a second region GR2. In each of the histograms H1 and H2, a X-axis indicates brightness and a Y-axis indicates the number of pixels at a brightness level by color (e.g., red (R), green (G), or blue (B)). For example, the first column of first histogram H1 could correspond to 10 pixels at 10% red, while the last column of the first histogram H1 could correspond to 20 pixels at 90% red, etc. The ISP 40 may compare each of the histograms H1 and H2 with each other and calculate a disparity ^{Δ}d according to a result of the comparison. The ISP 40 may set the disparity as a comparison coefficient, and perform a color compensation operation using a set comparison coefficient. In an exemplary embodiment, the disparity is the difference between the two histograms.

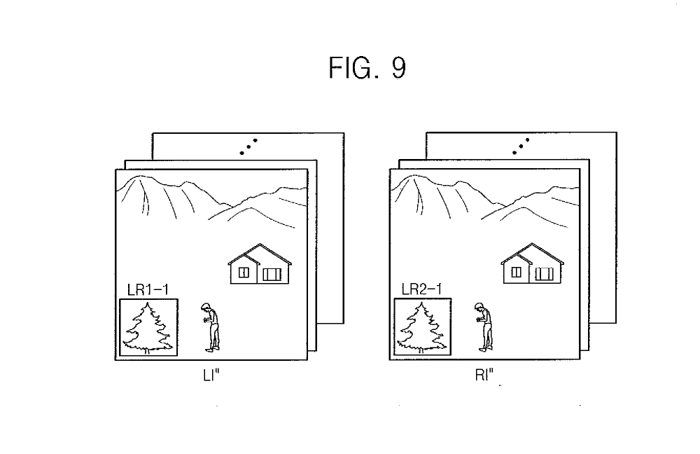

FIG. 9 depicts exemplary images for explaining an exemplary embodiment of a color compensation operation performed by the image signal processor illustrated in FIG. 1. Referring to FIGS. 1 through 9, the ISP 40 selects local regions LR1-1 and LR2-1 from each of stereo images LI″ and RI″ according to depth information.

Each of local regions LR1-1 and LR2-1 may be arbitrarily set according to the depth information. For example, the local regions may be selected using the depth information. According to an exemplary embodiment, the number or a size of each of the local regions LR1-1 and LR2-1 may be varied. The ISP 40 may perform a color compensation operation on some or each of selected local regions LR1-1 and LR2-1. For example, the ISP 40 calculates color similarity of the local regions LR1-1 and LR2-1.

The ISP 40 may generate a histogram depicting a brightness distribution of each of the local regions LR1-1 and LR2-1. The ISP 40 compares each of the histograms with each other and calculates a disparity among them according to a result of the comparison. The ISP 40 may set the disparity as a comparison coefficient and perform a color compensation operation using a set comparison coefficient.

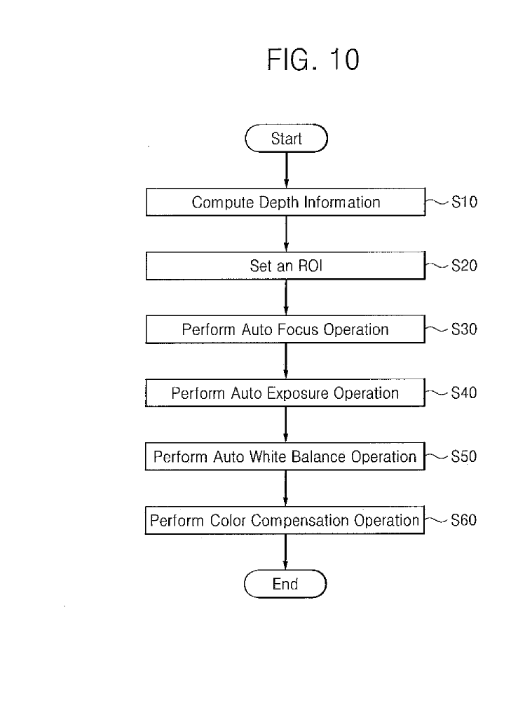

FIG. 10 is a flowchart for explaining an operation of the stereo vision device illustrated in FIG. 1 according to an exemplary embodiment of the inventive concept. Referring to FIGS. 1 through 10, the ISP 40 calculates depth information by analyzing the stereo images LI and RI generated by the image sensors 13 and 23 (S10).

The ISP 40 sets each of regions of interest ROI1-1 to ROI1-n and ROI2-1 to ROI2-n for each of the stereo images LI and RI by using the depth information (S20). The ISP 40 controls each of the auto focus controllers 15 and 25 so that an auto focus operation is performed on each of the regions of interest ROI1-1 to ROI1-n and ROI2-1 to ROI2-n (S30).

The ISP 40 controls each of the auto exposure controllers 17 and 27 so that an auto exposure operation is performed on each of the regions of interest ROI1-1 to ROI1-n and ROI2-1 to ROI2-n (S40). The ISP 40 divides each of the stereo images LI and RI into sub regions S1 to S6 and S1′ to S6′ according to the depth information, and controls each of the auto balance controllers 19 and 29 so that an auto white balance operation is performed on each of divided stereo images (S50).

The ISP 40 performs a color compensation operation on each of the stereo images when the auto focus operation, the auto exposure operation and the auto white balance operation are performed (S60).

A stereo vision device according to an exemplary embodiment of the present inventive concept and a control method thereof may ensure that the quality of stereo images are identical by controlling auto focus, auto exposure and auto white balance (3A) by using depth information.

Although exemplary embodiments of the present inventive concept have been shown and described, it will be appreciated by those skilled in the art that various changes may be made in these embodiments without departing from the spirit and scope of the inventive concept.

What is claimed is:

1. A method of controlling a stereo vision device, comprising:
calculating depth information by analyzing stereo images;
setting regions of interest within each of the stereo images by using the depth information; and
performing an auto focus operation on each of the regions of interest.

2. The method of claim 1, further comprising performing an auto exposure operation on each of the regions of interest.

3. The method of claim 1, further comprising:
dividing each of the stereo images into sub regions according to the depth information; and
performing an auto white balance operation on each of the divided stereo images.

4. The method of claim 3, wherein each of the sub regions comprises each of different sub parameters, and the auto white balance operation is performed based on an auto white balance parameter generated by adding the sub parameters.

5. The method of claim 1, further comprising performing a color compensation operation on each of the auto focused stereo images.

6. The method of claim 5, wherein the performing the color compensation operation comprises:
selecting each of local regions from each of the auto focused stereo images according to the depth information; and
performing the color compensation operation on each of the selected local regions.

7. A stereo vision device comprising:
image sensors configured to output stereo images:
lenses each located in front of each of the image sensors;
an image signal processor configured to calculate depth information by analyzing the stereo images and set regions of interest within each of the stereo images by using the depth information; and
an auto focus controller configured to adjust a location of each of the lenses to focus light on each of the regions of interest.

8. The stereo vision device of claim 7, further comprising an auto exposure controller configured to adjust an exposure time of each of the image sensors for each of the regions of interest.

9. The stereo vision device of claim 7, wherein the image signal processor is configured to divide each of the stereo images into sub regions according to the depth information.

10. The stereo vision device of claim 9, wherein each of the sub regions comprises each of different sub parameters.

11. The stereo vision device of claim 9, further comprising an auto white balance controller configured to control each of the image sensors to perform an auto white balance operation on each of the divided stereo images.

12. The stereo vision device of claim 7, wherein the image signal processor performs a color compensation operation on each of the auto focused stereo images.

13. The stereo vision device of claim 7, wherein the image signal processor selects each of local regions from each of the auto focused stereo images according to the depth information, and performs the color compensation operation on each of the selected local regions.

14. The stereo vision device of claim 7, wherein the stereo vision device is a 3D display device.

15. A method of controlling a stereo image device, comprises:
calculating depth information from a pair of stereo images;
defining a region of interest within each of the stereo images based on the depth information, where each region of interest surrounds only a part of the corresponding image; and
performing an auto exposure operation only on the regions of interest.

16. The method of claim 15, further comprising performing an auto focus operation only on the regions of interest.

17. The method of claim 15, further comprises:
dividing each stereo image into sub regions, wherein each sub region corresponds to a different depth;
selecting the sub region with the smallest depth for each stereo image; and
performing an auto white balance on each stereo image using the corresponding selected sub region.

18. The method of claim 16, further comprising performing a color compensation operation on each of the auto focused stereo images.

19. The method of claim 18, wherein the performing the color compensation operation comprises:
selecting each of local regions from each of the auto focused stereo images according to the depth information; and
performing the color compensation operation on each of the selected local regions.

20. The method of claim 15, wherein the depth information is calculated using a window matching method or a point correspondence analysis.
